(19) United States
(12) Patent Application Publication
(10) Pub. No.: US 2017/0299777 A1
(43) Pub. Date: Oct. 19, 2017

(54) OPTICAL FILM COATING COMPOSITION AND OPTICAL FILM COMPRISING THE SAME

(71) Applicant: LG CHEM, LTD., Seoul (KR)

(72) Inventors: Se-Jung Park, Gyeonggi-do (KR); Hong-Kwan Cho, Gyeonggi-do (KR); Jang-Soon Kim, Gyeonggi-do (KR)

(73) Assignee: LG Chem, Ltd., Seoul (KR)

(21) Appl. No.: 15/517,360

(22) PCT Filed: Oct. 14, 2015
(86) PCT No.: PCT/KR2015/010850

§ 371 Date: Apr. 6, 2017

(30) Foreign Application Priority Data
Oct. 16, 2014 (KR) 10-2014-0139990

(51) Int. Cl. G02B 1/115; B32B 7/04; B32B 27/36; B32B 9/00; B32B 27/30

(52) U.S. Cl. CPC G02B 1/115; B32B 9/007; B32B 27/308; B32B 27/36; B32B 7/04; B32B 2307/416; B32B 2307/42; B32B 2333/08; B32B 2264/102

(57) ABSTRACT

Provided is an optical film coating composition including: a UV curable acrylate resin; mixed particles including inorganic nanoparticles and carbon black; and a photoinitiator.

### TECHNICAL FIELD

The present invention relates to an optical film coating composition and an optical film including the same.

### BACKGROUND ART

Recently, electronic devices such as PDAs mobile communication terminals, or navigation systems for vehicles share a large part of an electronic market. Since an optical film for a display directly affects a user's visibility in the electronic device, the optical performance of the film becomes an important element.

In general, an optical film used in the OLED or a touch screen panel, and the like uses a polarizing film in order to secure optical characteristics such as visibility, and it is effective for improving the visibility due to the external light to use the optical film. However, there is a need for compensation in terms of reducing the luminance on a display screen, and simultaneously, studies for securing excellent optical characteristics have been actively conducted.

### DETAILED DESCRIPTION OF THE INVENTION

### Technical Problem

The present invention has been made in an effort to provide an optical film coating composition including: a UV curable acrylate resin; mixed particles including inorganic nanoparticles and carbon black; and a photoinitiator.

However, a technical problem to be achieved by the present invention is not limited to the aforementioned problems, and the other problems that are not mentioned may be clearly understood by the person skilled in the art from the following description.

### Technical Solution

The present invention provides an optical film coating composition including: a UV curable acrylate resin; mixed particles including inorganic nanoparticles and carbon black; and a photoinitiator.

It is possible to provide an optical film coating composition in which the inorganic nanoparticles include one or more selected from the group consisting of BaTiO₃, PbZrO₃, PbTiO₃, ZnO, ZrO₂, HfO₂, SrTiO₃, SnO₂, CeO₂, MgO, NiO, CaO, Y₂O₃, TiO₂, SiO₂, SiC, and a combination thereof.

It is possible to provide an optical film coating composition in which the inorganic nanoparticles have an average particle diameter of 10 nm to 100 nm.

It is possible to provide an optical film coating composition in which the carbon black has a particle diameter of 5 μm to 25 μm.

It is possible to provide an optical film coating composition in which a weight ratio of the inorganic nanoparticles to the carbon black is 85:15 to 90:10.

It is possible to provide an optical film coating composition in which the photoinitiator includes one or more selected from the group consisting of benzoin methyl ether, 2,4,6-trimethylbenzoyl diphenylphosphine oxide, bis(2,4,6-trimethylbenzoyl) phenylphosphine oxide, α,α-methoxy-α-hydroxyacetophenone, 2-benzoyl-2-(dimethylamino)-1-[4-(4-morpholinyl) phenyl]-1-butanone, 2,2-dimethoxy-2-phenylacetophenone, 2,2-dimethoxy-1,2-diphenylethan-1-one, 1-hydroxy-cyclohexyl-phenyl ketone, 2-benzyl-2-(dimethylamino)-1-[4-(4-morpholinyl)phenyl]-1-butanone, and a combination thereof.

It is possible to provide an optical film coating composition including 10 to 30 parts by weight of the mixed particles and 1 to 5 parts by weight of the photoinitiator based on 100 parts by weigh of the UV curable acrylate resin.

The present invention provides an optical film including: an adhesive layer; a base layer formed on an upper portion of the adhesive layer; and a coating layer formed on an upper portion of the base layer, in which the coating layer is formed by curing the optical film coating composition according to any one of claims 1 to 7.

It is possible to provide an optical film in which the adhesive layer includes one or more selected from the group consisting of an urethane binder, polyester, polyolefin, an acrylic binder, and a combination thereof.

It is possible to provide an optical film in which the base layer is formed of polyethylene terephthalate (PET), polyethylene naphthalate (PEN), polycarbonate (PC), a cyclic olefin polymer or copolymer, or a methylene diphenyl diisocyanate (MDI) material.

It is possible to provide an optical film in which the coating layer has a thickness of 0.5 μm to 1 μm.

It is possible to provide an optical film in which the coating layer has a color difference L* of 95 to 99.

It is possible to provide an optical film in which the coating layer has a color difference a* of −0.16 to −0.01.

It is possible to provide an optical film in which the coating layer has a color difference b* of 0.5 to 1.

It is possible to provide an optical film in which the coating layer has a light transmittance of 90% to 98%.

It is possible to provide an optical film in which the coating layer has a reflective index of 1.4 to 1.5.

### Advantageous Effects

An optical film coating composition according to the present invention may include mixed particles composed of inorganic nanoparticles and carbon black to adjust the transmittance depending on the weight ratio of the inorganic nanoparticles and the carbon black, and may adjust the color difference by maintaining the thickness of the coating layer to 0.5 μm to 1 μm.

An optical film including the optical film coating composition may be applied to the OLED or a touch panel to implement excellent optical characteristics such as excellent visibility and high luminance.

### BRIEF DESCRIPTION OF DRAWINGS

FIG. 1 schematically illustrates the cross-section of an optical film according to an exemplary embodiment of the present invention.

### BEST MODE

The present inventors have conducted studies on an optical film for a display, and as a result, have confirmed that the transmittance of the optical film may be adjusted by adjusting the weight ratio of inorganic nanoparticles and carbon black, and the color difference may be adjusted for each thickness of a coating layer, thereby completing the present invention.

Hereinafter, exemplary embodiments of the present invention will be described in detail with reference to the accompanying drawings so that a person with ordinary skill in the art to which the present invention pertains can easily carry out the present invention. The present invention can be implemented in various different forms, and is not limited to the exemplary embodiments described herein.

To clearly describe the present invention, parts irrespective of the description are omitted, and the same reference numerals will be given to the same or similar constituent elements throughout the specification.

In the drawings, the thicknesses of several layers and regions are enlarged so as to clearly express the layers and the regions. Moreover, in the drawings, the thicknesses of some layers and regions are exaggerated for convenience of explanation.

Hereinafter, the formation of any configuration at “an upper portion (or a lower portion)” of a base material or “on (or below)” of the base material means that any configuration is formed to be brought into contact with an upper surface (or a lower surface) of the base material, and does not limit that another configuration is not included between the base material and any configuration formed on (or below) the base material.

Optical Film Coating Composition

The present invention provides an optical film coating composition including: a UV curable acrylate resin; mixed particles including inorganic nanoparticles and carbon black; and a photoinitiator.

The optical film coating composition may be used as a use such as the OLED or a touch screen panel, and in this case, needs to have characteristics of enhancing the luminance and having excellent visibility. For this purpose, the optical film coating composition may include mixed particles having specific kinds of inorganic nanoparticles and a specific kind of carbon black at a specific content ratio to adjust the transmittance and color difference, thereby implementing optical characteristics such as high luminance and excellent visibility.

First, the optical film coating composition according to the present invention includes a UV curable acrylate resin, and the UV curable acrylate resin serves as a binder which holds nanoparticles inside the coating layer, and may be an acrylate monomer or oligomer. In this case, as the acrylate monomer, various photo-curable acrylate monomers may be used, and examples thereof include bifunctional acrylates such as 1,2-ethylene glycol diacrylate, 1,12-dodecanediol acrylate, 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, hydroxyl pivalic acid neopentyl glycol di(meth)acrylate, dicyclopentanyl di(meth)acrylate, caprolactone-modified dicyclopentenyl di(meth)acrylate, ethylene oxide-modified di(meth)acrylate, di(meth)acryloxy ethyl isocyanurate, allylated cyclohexyl di(meth)acrylate, tricyclodecane dimethanol(meth)acrylate, dimethylol dicyclopentane di(meth)acrylate or 9,9-bis[4-(2-acryloyloxyethoxy)phenyl]fluorene and the like, ethylene oxide-modified hexahydrophthalic acid di(meth)acrylate, tricyclodecane dimethanol (meth)acrylate, neopentyl glycol-modified trimethylpropane di(meth)acrylate, and adamantane di(meth)acrylate; more preferably, trifunctional acrylates such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trifunctional urethane (meth) acrylate, or tris(meth)acryloxyethyl isocyanurate; tetrafunctional acrylates such as diglycerin tetra(meth)acrylate or pentaerythritol tetra(meth)acrylate; pentafunctional acrylates such as propionic acid-modified dipentaerythritol penta(meth)acrylate; and hexafunctional acrylates such as dipentaerythritol hexa(meth)acrylate, caprolactone-modified dipentaerythritol hexa(meth)acrylate, or urethane (meth)acrylate (for example, reaction products of isocyanate monomers and trimethylolpropane tri(meth)acrylate), and the like, but are not limited thereto.

In this case, as the acrylate oligomer, various photo-curable epoxy acrylate oligomers, ester acrylate oligomers, cardo-based acrylate oligomers, and the like can be used, and urethane acrylate oligomers are more preferred.

The urethane acrylate oligomer is formed by a polymerization reaction of an isocyanate-based monomer and a polyol, the isocyanate-based compound includes at least one or more selected from an aliphatic isocyanate-based compound, an aromatic isocyanate-based compound, and a combination thereof, and the polyol may be a (meth)acrylic acid hydroxy alkyl ester-based compound.

The epoxy acrylate may include at least one or more selected from bisphenol A diglycidyl ether, hydrogenated bisphenol A diglycidyl ether, a (meth)acrylic acid adduct of a phenol novolac epoxy resin, and a combination thereof.

The ester acrylate may include a polyfunctional polyester acrylate-based compound of a polyhydric alcohol.

The cardo-based acrylate may be a compound to which a photo-curable acrylate is imparted by reacting at least one selected from the group consisting of a cardo-based compound, a dianhydride compound, a diol compound, diacrylic acid, and a combination thereof. Further, the acrylate resin is preferably a polyfunctional acrylate resin, and more preferably a bifunctional to hexafunctional (having 2 to 6 acrylate groups) acrylate resin, but is not limited thereto.

The monomer or oligomer has an excellent UV curing rate when the monomer or oligomer has a larger molecular weight, so that the curing rate may be increased by increasing the number of moles of the acrylic groups in the molecule thereof, and increasing the polyfunctional number.

Next, the optical film coating composition includes inorganic nanoparticles, and the inorganic nanoparticles may include one or more selected from the group consisting of BaTiO₃, PbZrO₃, PbTiO₃, ZnO, ZrO₂, HfO₂, SrTiO₃, SnO₂, CeO₂, MgO, NiO, CaO, Y₂O₃, TiO₂, SiO₂, SiC, and a combination thereof, and more preferably, include SiO₂, TiO₂, and a combination thereof.

The inorganic nanoparticles may have an average particle diameter of 10 to 100 nm. Excellent optical characteristics may be implemented by maintaining a particle diameter within the range.

The mixed particles of the optical film coating composition include carbon black, and the carbon black is a fine carbon powder, and the particle is usually spherical and has high rigidity and micropores because fine crystals are arranged in parallel with the surface thereof.

The carbon black may have a particle diameter of 5 to 25 μm.

That is, the inorganic particles maintain a nanoparticle diameter within the range and the carbon black maintains a micro particle diameter within the range, and accordingly, the inorganic nanoparticles are collected and alternately arranged at an empty space between the carbon blacks in the mixed particles to form a coating layer. For the coating layer, the refractive index is changed according to the content of the inorganic nanoparticles, and a layer having a thickness, which easily experiences light interference, is formed by coating the optical film with the layer having a different refractive index, and the color difference may be adjusted by forming the layer.

The weight ratio of the inorganic nanoparticles to the carbon black may be 85:15 to 90:10.

In the mixed particles, when the weight ratio of the inorganic nanoparticles to the carbon black is out of the range, for example, about 95:about 5, there is a concern in that it is difficult to adjust the color difference because the inorganic nanoparticles are added in an excess amount, and when the weight ratio is, for example, about 60:about 40, there is a concern in that the light transmittance is reduced more than needed because the carbon black is added in an excess amount.

The photoinitiator may include one or more selected from the group consisting of benzoin methyl ether, 2,4,6-trimethylbenzoyl diphenylphosphine oxide, bis(2,4,6-trimethylbenzoyl) phenylphosphine oxide, α,α-methoxy-α-hydroxyacetophenone, 2-benzoyl-2-(dimethylamino)-1-[4-(4-morpholinyl) phenyl]-1-butanone, 2,2-dimethoxy-2-phenylacetophenone, 2,2-dimethoxy-1,2-diphenylethan-1-one, 1-hydroxy-cyclohexyl-phenyl ketone, 2-benzyl-2-(dimethylamino)-1-[4-(4-morpholinyl)phenyl]-1-butanone, and a combination thereof.

Since the optical film coating composition may include a photoinitiator, the photo-curable monomer may be cured at the time of light irradiation, and a cured product may be formed from the optical film coating composition by curing the photo-curable monomer.

The optical film coating composition may include about 10 to about 30 parts by weight of the mixed particles and about 1 to about 5 parts by weight of the photoinitiator based on 100 parts by weight of the UV curable acrylate resin.

By including the mixed particles and the photoinitiator in an amount of parts by weight within the range, the photo-curing efficiency of the optical film coating composition may be maximized, and a more advantageous effect may be implemented in terms of securing manufacturing costs and optical characteristics such as light transmittance and color difference.

The optical film coating composition may include a solvent. The solvent is preferably one or more selected from the group consisting of propylene glycol monomethyl ether acetate (PGMEA), toluene, ethyl acetate, butyl acetate, acetone, methanol, butyl carbitol, butyl carbitol acetate, butyl cellosolve, butyl cellosolve acetate, and terpineol, but is not limited thereto.

Optical Film

Further, the present invention provides an optical film including: an adhesive layer; a base layer formed on an upper portion of the adhesive layer; and a coating layer formed on an upper portion of the base layer, in which the coating layer is formed by curing the optical film coating composition.

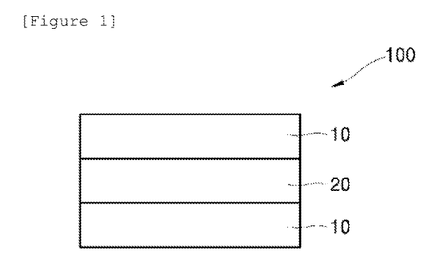

FIG. 1 schematically illustrates the cross-section of the optical film according to the present invention.

As illustrated in FIG. 1, an optical film 100 according to the present invention includes an adhesive layer 10, a base layer 20, and a coating layer 30.

The adhesive layer 10 may include one or more selected from the group consisting of a urethane binder, polyester, polyolefin, an acrylic binder, and a combination thereof.

The base layer 20 may be glass; a transparent film; or a polymer film such as polyester, polycarbonate, polyolefin, and a polyvinyl resin. The base layer 20 is most preferably formed of polyethylene terephthalate (PET), polyethylene naphthalate (PEN), polycarbonate (PC), a cyclic olefin polymer or copolymer, or a methylene diphenyl diisocyanate (MDI) material in terms of processability, thermal stability, and transparency. Further, the surface of the base layer 20 can be modified with a surface treatment known to a person with ordinary skill in the art, for example, a surface treatment such as corona and plasma to adjust adhesive property, surface tension, and the like during the subsequent process.

It is possible to additionally include a primer layer formed on the base layer 20. The primer layer may control the temperature transfer between the base layer 20 and an adjacent layer, and may improve the adhesive property between the base layer 20 and the adjacent layer. As a material suitable for the primer layer, it is possible to use one or more selected from the group consisting of an acrylic resin, a polyurethane-based resin, and a polyester-based resin.

The coating layer 30 may have a thickness of about 0.5 μm to about 1 μm. When the thickness of the coating layer 30 is less than about 0.5 μm, there is a problem in that it is difficult to secure the thickness uniformity of the coating layer 30 according to the formation, and when the thickness is more than about 1 μm, there is a problem in that the curing property for forming a coating film deteriorates, and the coating layer 30 after curing becomes vulnerable to cracks, and accordingly, it is possible to implement excellent optical characteristics within the range.

When the cured product is irradiated with white light (D65) in accordance with a colorimetric system established by the Commission International de L'Eclairage (CIE, International Commission on Illumination), a color difference caused by light to be transmitted may be represented by CIE L*, a*, and b* which are defined such that a distance between two colors in a color space corresponds to a difference in color observed by a person, based on a CIE 10° standard observer (CIE 1964). In this case, L*, a*, and b* represent brightness, a value between Red and Green, and a value between Yellow and Blue, respectively, and accordingly, the values derived with respect to transmitted light when the cured product is irradiated with white light (D65) in a wavelength region of about 380 nm to about 780 nm may be represented by the color difference a* and the color difference b*.

The coating layer 30 may have a color difference b* of about 0.5 to about 1, and specifically, about 0.6 to about 0.8.

The color difference is an element which greatly affects the high-temperature reliability of an adhesive, the color difference is adjusted according to the thickness of the coating layer 30, and for example, when the coating layer 30 has a thickness of about 0.5 μm, the color difference b* may be about 0.86, and the coating layer 30 has a thickness of about 0.8 μm, the color difference may be about 0.34. It is possible to implement an effect of securing excellent visibility even at high temperature by adjusting the color difference according to the thickness of the coating layer 30 to remove the optical interference as compared to the adjustment of the color difference by means of an existing dye.

Meanwhile, the coating layer 30 may have a color difference a* of about −0.16 to about −0.01. The color difference a* of the cured product satisfies the range, and as a result, the absolute values of the color differences a* and b* is close to 0, so that it is possible to prevent the Moiré phenomenon and secure excellent visibility when the cured product is used for a touch panel, and the like.

The coating layer 30 may have a color difference L* of about 95 to about 99. The color difference L* of the cured product satisfies the range, and as a result, there is an effect of preventing the visibility of a display by means of external light from being suppressed when the cured product is used in a touch panel, and the like.

The coating layer 30 may have a light transmittance of about 90% to about 98%. The weight ratio of the inorganic nanoparticles to the carbon black in the mixed particles of the optical film coating composition may be maintained at about 85:about 15 to about 90:about 10, and as a result, the coating layer 30 including the optical film coating composition may secure a light transmittance of about 90% to about 98%. When the light transmittance is less than about 80%, there is a concern in that it is difficult for the coating layer 30 to implement excellent transparency, and for example, when the coating layer 30 is used for the OLED or a touch panel, excellent optical characteristics fail to be implemented.

The coating layer 30 may have a refractive index of about 1.4 to about 1.5. The coating layer 30 satisfies a refractive index within the range, and as a result, it is possible to implement excellent visibility and implement an advantage in that as the coating layer 30 is disposed on the upper portion of the base layer 20, the reflectance is decreased and the contrast ratio is improved.

Hereinafter, specific examples of the present invention will be suggested. However, the Examples described below are only provided for specifically exemplifying or explaining the present invention, and the present invention is not limited thereby.

### EXAMPLES AND COMPARATIVE EXAMPLES

### Example 1

An optical film coating composition including 25 parts by weight of a UV curable acrylate resin (UN-907, Negami Co., Ltd.), 20.7 parts by weight of inorganic nanoparticles (Thrulya 4110, JGC C&C Co., Ltd.), 2.3 parts by weight of carbon black, 2 parts by weight of a photoinitiator (Irgacure 184, Ciba-Geigy Co., Ltd.), and 50 parts by weight of solvents (methyl ethyl ketone, propylene glycol methyl ether, and dimethylformamide) was manufactured.

The composition was coated to have a thickness of 0.5 μm on the upper portion of a polyethylene terephthalate base layer (U48, Toray Co., Ltd.) by a bar coating method, thereby manufacturing an optical film.

### Example 2

An optical film was manufactured in the same manner as in Example 1, except that 19.5 parts by weight of the inorganic nanoparticles and 3.5 parts by weight of the carbon black were included.

### Comparative Example 1

An optical film was manufactured in the same manner as in Example 1, except that 16 parts by weight of the inorganic nanoparticles and 7 parts by weight of the carbon black were included.

### Comparative Example 2

An optical film was manufactured in the same manner as in Example 1, except that the coating layer had a thickness of 3 μm.

### EXPERIMENTAL EXAMPLES

1) Measurement of Light Transmittance

A light transmittance was measured by using a UV-vis spectrometer under a normal temperature condition of 20° C. to 30° C.

2) Measurement of Refractive Index

A refractive index was measured by using a prism coupler (SPA-4000) under a normal temperature condition of 20° C. to 30° C.

3) Measurement of Color Difference

A color difference was measured by using CM-5 (Konica Minolta Co., Ltd., a color difference meter) under a normal temperature condition of 20° C. to 30° C.

TABLE 1

| | Optical characteristics | | | | |
|---|---|---|---|---|---|
| | Light | Refrac- | Color | Color | Color |
| Classi- | transmittance | tive | difference | difference | difference |
| fication | (%) | index | b* | a* | L* |
| Example 1 | 95.72 | 1.45 | 0.86 | −0.16 | 98.32 |
| Example 2 | 95.30 | 1.48 | 0.84 | −0.01 | 98.16 |
| Comparative | 79.75 | 1.53 | 0.35 | −0.11 | 82.51 |
| Example 1 | | | | | |
| Comparative | 94.37 | 1.45 | 3.63 | −1.29 | 97.78 |
| Example 2 | | | | | |

As shown in Table 1, it can be seen that the optical films in Examples 1 and 2 include the inorganic nanoparticles and the carbon black at a predetermined weight ratio of about 5.5:1 to about 9:1, and have a refractive index of 1.4 to 1.5, the light transmittance shown to be 95% or more, and as a result, excellent visibility is implemented. Simultaneously, since the optical film implements a color difference b* between 0 and 1, a color difference a* relatively close to 0, and a color difference L* of about 98 or more, it is possible to implement an effect in which the step absorption difference performance is excellent and visibility and transparency are improved.

In Comparative Example 1, the weight ratio of the inorganic nanoparticles to the carbon black is about 2.3:1, which is different from the weight ratio of the present invention, the light transmittance is 79.75%, which is at a low level, and the refractive index exceeds 1.5. Further, since the color difference L* is 82.51, which is shown to be lower than those in Examples 1 and 2, it can be seen that Examples 1 and 2 implement better optical characteristics.

Since Comparative Example 2 is an optical film in which the coating layer has a thickness of 3 μm, and the absolute values of the color differences b* and a* are significantly less than or more than 0, it can be seen that in Comparative Example 2, the visibility is poor because the color difference is not adjusted well as compared to the optical film according to the present invention.

### EXPLANATION OF REFERENCE NUMERALS AND SYMBOLS

100: Optical film
10: Adhesive layer
20: Base layer
30: Coating layer

1. An optical film coating composition comprising: a UV curable acrylate resin; mixed particles including inorganic nanoparticles and carbon black; and a photoinitiator.

2. The optical film coating composition of claim 1, wherein the inorganic nanoparticles comprise one or more selected from the group consisting of BaTiO₃, PbZrO₃, PbTiO₃, ZnO, ZrO₂, HfO₂, SrTiO₃, SnO₂, CeO₂, MgO, NiO, CaO, Y₂O₃, TiO₂, SiO₂, SiC, and a combination thereof.

3. The optical film coating composition of claim 1, wherein the inorganic nanoparticles have an average particle diameter of 10 nm to 100 nm.

4. The optical film coating composition of claim 1, wherein the carbon black has a particle diameter of 5 μm to 25 μm.

5. The optical film coating composition of claim 1, wherein a weight ratio of the inorganic nanoparticles to the carbon black is 85:15 to 90:10.

6. The optical film coating composition of claim 1, wherein the photoinitiator comprises one or more selected from the group consisting of benzoin methyl ether, 2,4,6-trimethylbenzoyl diphenylphosphine oxide, bis(2,4,6-trimethylbenzoyl) phenylphosphine oxide, α,α-methoxy-α-hydroxyacetophenone, 2-benzoyl-2-(dimethylamino)-1-[4-(4-morpholinyl) phenyl]-1-butanone, 2,2-dimethoxy-2-phenylacetophenone, 2,2-dimethoxy-1,2-diphenylethan-1-one, 1-hydroxy-cyclohexyl-phenyl ketone, 2-benzyl-2-(dimethylamino)-1-[4-(4-morpholinyl)phenyl]-1-butanone, and a combination thereof.

7. The optical film coating composition of claim 1, wherein the optical film coating composition comprises 10 to 30 parts by weight of the mixed particles and 1 to 5 parts by weight of the photoinitiator based on 100 parts by weight of the UV curable acrylate resin.

8. An optical film comprising:
an adhesive layer;
a base layer formed on an upper portion of the adhesive layer; and
a coating layer formed on an upper portion of the base layer,
wherein the coating layer is formed by curing the optical film coating composition according to claim 1.

9. The optical film of claim 8, wherein the adhesive layer comprises one or more selected from the group consisting of a urethane binder, polyester, polyolefin, an acrylic binder, and a combination thereof.

10. The optical film of claim 8, wherein the base layer is formed of polyethylene terephthalate, polyethylene naphthalate, polycarbonate, a cyclic olefin polymer or copolymer, or a methylene diphenyl diisocyanate material.

11. The optical film of claim 8, wherein the coating layer has a thickness of 0.5 μm to 1 μm.

12. The optical film of claim 8, wherein the coating layer has a color difference L* of 95 to 99.

13. The optical film of claim 8, wherein the coating layer has a color difference a* of −0.16 to −0.01.

14. The optical film of claim 8, wherein the coating layer has a color difference b* of 0.5 to 1.

15. The optical film of claim 8, wherein the coating layer has a light transmittance of 90% to 98%.

16. The optical film of claim 8, wherein the coating layer has a reflective index of 1.4 to 1.5.
